(19) United States
(12) Patent Application Publication
(10) Pub. No.: US 2006/0139214 A1
(43) Pub. Date: Jun. 29, 2006

(54) Antenna

(76) Inventors: Sheng-Ming Deng, Hsinchu (TW); Cho-Kang Hsu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/316,933

(22) Filed: Dec. 27, 2005

(30) Foreign Application Priority Data
Dec. 28, 2004 (TW) 93221065

(51) Int. Cl. H01Q 1/38; H01Q 1/24

(52) U.S. Cl. 343/700 MS; 343/702

(57) ABSTRACT

The present invention describes an antenna assembly. The antenna assembly has a planar antenna structure and a conductor. The planar antenna structure has at least three metallic sheets and is electrically connected with the conductor. The present invention is used to receive multiple frequency signals and produce a coupled effect. The conductor is connected with a planar substrate. The present invention is used to enlarge an operating frequency band of the signals using electromagnetic waves. Further, the frequency response of the antenna assembly is improved.

### BACKGROUND OF THE INVENTION

1. Field of the Invention

The present invention relates to an antenna, and in particular to an antenna assembly connected with a conductor and positioned at one side of a planar substrate.

2. Description of Related Art

Reference is made to FIG. 1. FIG. 1 illustrates a perspective view of a conventional antenna. According to FIG. 1, the conventional antenna includes a planar substrate 1a, a planar antenna structure 2a, and a connection conductor 3a. The planar antenna structure 2a includes a metallic sheet 20a, and the connection conductor 3a is a metallic conductor and positioned at one side of the planar substrate 1a to connect the metallic sheet 20a.

However, the conventional antenna has a disadvantage. The planar antenna structure 2a only includes the metallic sheet 20a so that the conventional antenna cannot be implemented for wideband application. In this regard, there are shortcomings and inconveniences for the conventional antenna.

### SUMMARY OF THE INVENTION

Antenna design is critical for mobile phones. Antenna design has great impact on the quality of communication, appearance, and size of a mobile phone.

It is an object of the present invention to provide an antenna assembly. The antenna assembly includes a planar antenna structure and a conductor, and is used to receive and transmit signals using electromagnetic waves of three frequencies (900 MHz, 1800 MHz or 1900 MHz).

It is another object of the present invention to provide an antenna assembly. A planar antenna structure of the antenna assembly is adjusted so that the antenna assembly can receive and transmit Bluetooth signals using wireless frequency (2.4 GHz).

To achieve the object of the present invention, the antenna assembly comprises a planar antenna structure and a conductor. The planar antenna structure has at least three metallic sheets and is electrically connected with the conductor. The present invention is used to receive multiple frequency signals and produce a coupled effect. The conductor is connected with a planar substrate.

### BRIEF DESCRIPTION OF THE DRAWINGS

The present invention can be fully understood from the following detailed description and preferred embodiment with reference to the accompanying drawings, in which:

FIG. 1 is a perspective view of a conventional antenna;

FIG. 2 is a perspective view of an antenna assembly according to the first embodiment of the present invention;

FIG. 3 is a perspective view of an antenna assembly according to the second embodiment of the present invention;

FIG. 4 is a perspective view of an antenna assembly according to the third embodiment of the present invention;

FIG. 5 is a perspective view of an antenna assembly according to the fourth embodiment of the present invention;

FIG. 6 is a perspective view of an antenna assembly according to the fifth embodiment of the present invention;

FIG. 7 is a frequency response plot of an antenna assembly according to the present invention; and

FIGS. 8A to 8C illustrate radiation patterns corresponding to the frequency response plot of an antenna assembly according to the present invention.

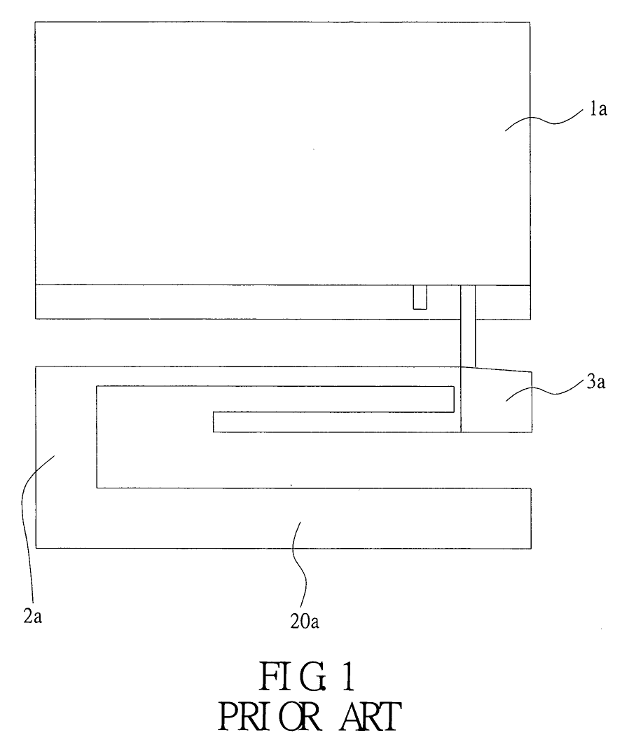

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

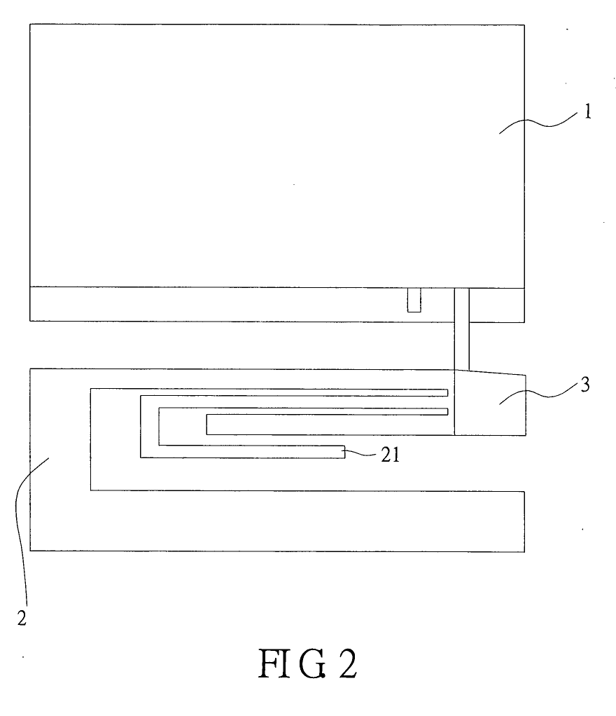

Reference is made to FIG. 2. FIG. 2 illustrates a perspective view of an antenna assembly according to the first embodiment of the present invention. According to the present invention, an antenna assembly includes a planar substrate 1, a planar antenna structure 2 and a conductor 3.

The planar substrate 1 is, for example, a metallic board or a printed circuit board. The printed circuit board is made of Bakelite board, ceramic substrate, cardboard, copper foil substrate, flexible board, hard board, metallic substrate or thermoplastic substrates. The planar antenna structure 2 includes at least three metallic sheets and is electrically connected with the conductor 3. The planar antenna structure 2 is planar, curved or winding. As shown in FIG. 2, the metallic sheet 21 is used to receive multiple frequency signals and produce a coupled effect. According to the embodiment, the present invention includes one metallic sheet. Additionally, the present invention may include a plurality of metallic sheets. The planar antenna structure includes at least three metallic sheets that are L-shaped or U-shaped. The combination and the size of these metallic sheets are arbitrary. Frequencies of these metallic sheets correspond to a plurality of operating frequencies including 900 MHz, 1800 MHz, 1850 MHz, 1990 Mhz, and 2450 MHz. According to the present invention, the metallic sheet can be used as a ground wire.

The conductor 3 is a metallic conductor positioned at one side of the planar substrate 1 and used to connect the planar substrate 1 and the planar antenna structure 2.

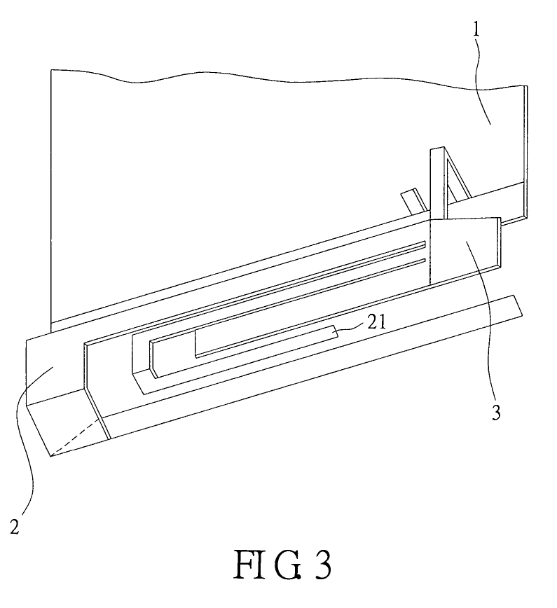

Reference is made to FIG. 3. FIG. 3 illustrates a perspective view of an antenna assembly according to the second embodiment of the present invention. According to the present invention, an antenna assembly includes a planar substrate 1, a planar antenna structure 2 and a conductor 3.

The planar substrate 1 is, for example, a metallic board or printed circuit board. The printed circuit board is made of Bakelite board, ceramic substrate, cardboard, copper foil substrate, flexible board, hard board, metallic substrate or thermoplastic substrates. The planar antenna structure 2 includes at least three metallic sheets and is electrically connected with the conductor 3. The planar antenna structure 2 is planar, curved or winding. As shown in FIG. 2, the metallic sheet 21 is used to receive multiple frequency signals and produce a coupled effect. According to the embodiment, the present invention includes one metallic sheet. The present invention may also include a plurality of metallic sheets. The planar antenna structure includes at least three metallic sheets that are L-shaped or U-shaped. The combination and the size of these metallic sheets are arbitrary. Frequencies of these metallic sheets correspond to a plurality of operating frequencies including 900 MHz, 1800 MHz, 1850 MHz, 1990 MHz or 2450 MHz. According to the present invention, the metallic sheet can be used as a ground wire.

The conductor 3 is a metallic conductor positioned at one side of the planar substrate 1 and used to connect the planar substrate 1 and the planar antenna structure 2.

The planar antenna structure 2 is curved so that the planar antenna structure of the antenna assembly operates in a wider range of operating frequencies and can receive and transmit Bluetooth signals using a wireless frequency (2.4 GHz).

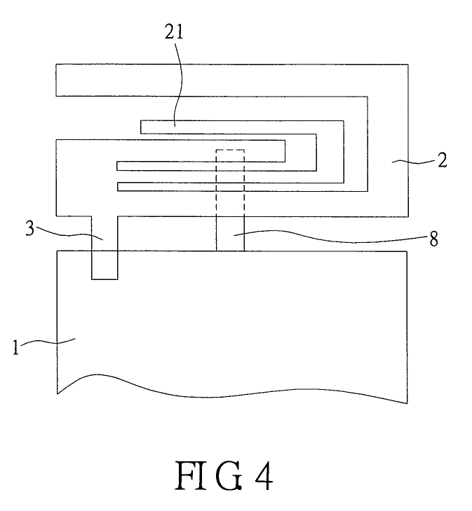

Reference is made to FIG. 4. FIG. 4 illustrates a perspective view of an antenna assembly according to the third embodiment of the present invention. According to the present invention, an antenna assembly includes a planar substrate 1, a planar antenna structure 2 and a conductor 3.

The planar substrate 1 is, for example, a metallic board or printed circuit board. The printed circuit board is made of Bakelite board, ceramic substrate, cardboard, copper foil substrate, flexible board, hard board, metallic substrate or thermoplastic substrates. The planar antenna structure 2 includes at least three metallic sheets and electrically connected with the conductor 3, and the planar antenna structure 2 is planar, curved or winding. As shown in FIG. 2, the metallic sheet 21 is used to receive multiple frequency signals and produce a coupled effect. According to the embodiment, the present invention includes one metallic sheet. The present invention may include a plurality of metallic sheets. The planar antenna structure also includes at least three metallic sheets that are L-shaped or U-shaped. The combination and the size of these metallic sheets are arbitrary. Frequencies of these metallic sheets correspond to a plurality of operating frequencies including 900 MHz, 1800 MHz, 1850 MHz, 1990 MHz and 2450 MHz. According to the present invention, the metallic sheet can be used as a ground wire.

The conductor 3 is a metallic conductor positioned at one side of the planar substrate 1 and used to connect the planar substrate 1 and the planar antenna structure 2.

According to the third embodiment, at least one metallic sheet 8 is extended from the planar substrate to produce a coupled effect. The metallic sheet 8 is not in contact with the metallic sheet 21 of the planar antenna structure 2.

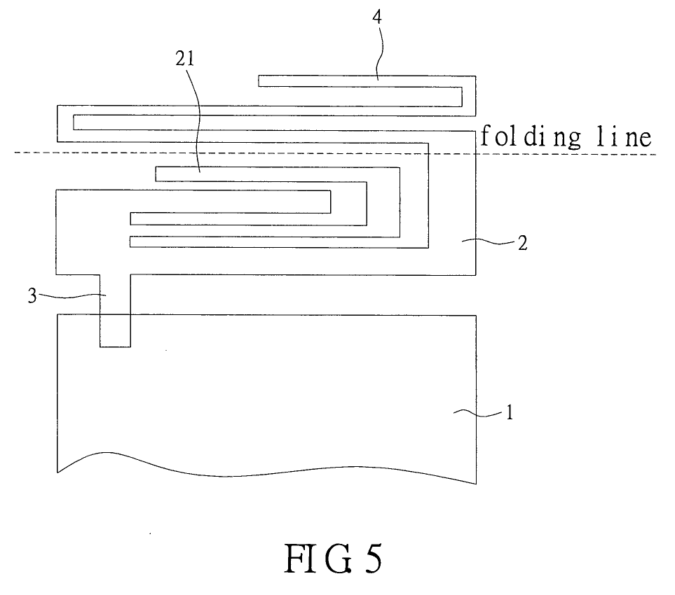

Reference is made to FIG. 5. FIG. 5 illustrates a perspective view of an antenna assembly according to the fourth embodiment of the present invention. According to the present invention, an antenna assembly includes a planar substrate 1, a planar antenna structure 2 and a conductor 3.

The planar substrate 1 is, for example, a metallic board or printed circuit board. The printed circuit board is made of Bakelite board, ceramic substrate, cardboard, copper foil substrate, flexible board, hard board, metallic substrate or thermoplastic substrates. The planar antenna structure 2 includes at least three metallic sheets and is electrically connected with the conductor 3. The planar antenna structure 2 is planar, curved or winding. As shown in FIG. 2, the metallic sheet 21 is used to receive multiple frequency signals and produce a coupled effect. According to the embodiment, the present invention includes one metallic sheet. The present invention may also include a plurality of metallic sheets. The planar antenna structure includes at least three metallic sheets that are L-shaped or U-shaped. The combination and the size of these metallic sheets are arbitrary. Frequencies of these metallic sheets correspond to a plurality of operating frequencies including 900 MHz, 1800 MHz, 1850 MHz, 1990 MHz or 2450 MHz. According to the present invention, the metallic sheet can be used as a ground wire.

The conductor 3 is a metallic conductor positioned at one side of the planar substrate 1 and used to connect the planar substrate 1 and the planar antenna structure 2.

According to the fourth embodiment, the present invention operates in a wider range of operating frequencies and the frequency is shifted. The planar antenna structure 2 is folded along a folding line so that a volume of the antenna can be significantly decreased.

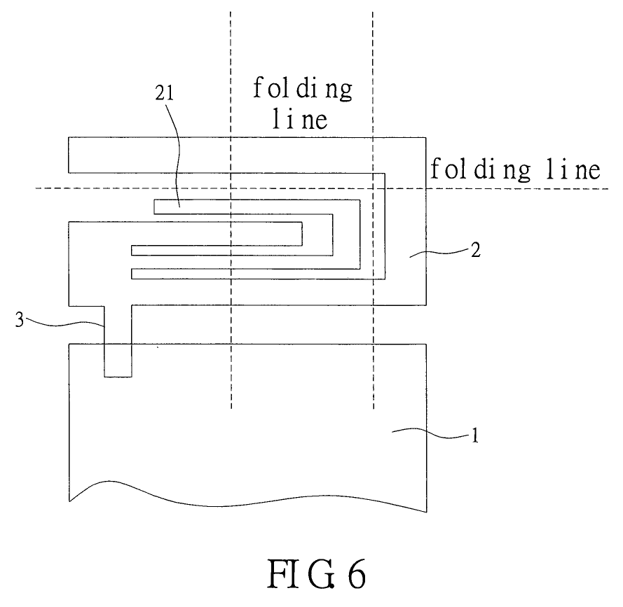

Reference is made to FIG. 6. FIG. 6 illustrates a perspective view of an antenna assembly according to the fifth embodiment of the present invention. According to the present invention, an antenna assembly includes a planar substrate 1, a planar antenna structure 2 and a conductor 3.

The planar antenna structure 2 is folded along a folding line. The planar antenna structure 2 can be folded along a vertical folding line or along the horizontal folding line so that the volume of the planar antenna structure 2 can be significantly decreased.

Reference is further made to FIGS. 2-6. The first embodiment and the second embodiment are applicable to:

1. Non-foldable mobile phone: The antenna assembly is positioned within the non-foldable mobile phone so that an antennaless mobile phone is formed.

2. Foldable mobile phone: The antenna assembly is positioned near the pivot of the mobile phone so that an antennaless mobile phone is formed and the antenna assembly has no adverse impact on operability of the mobile phone.

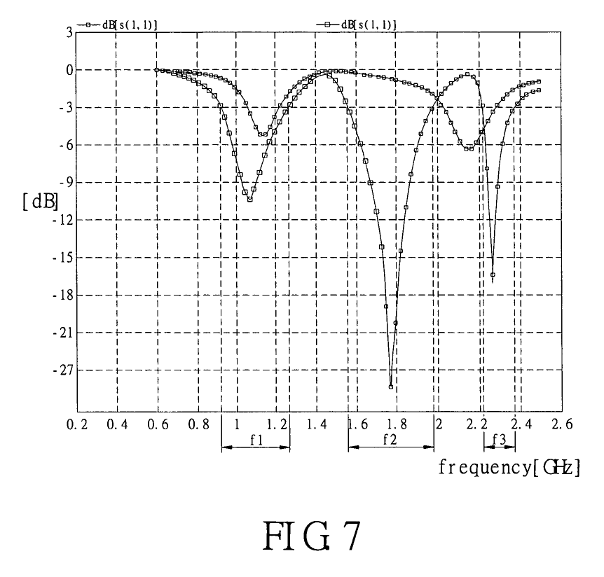

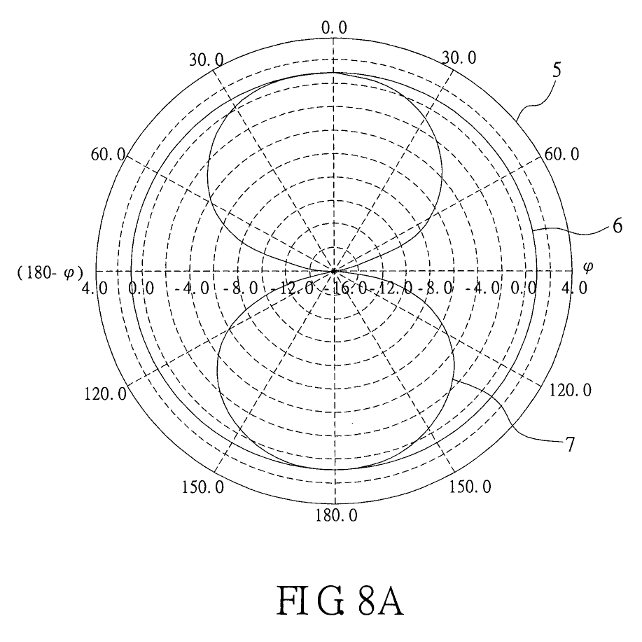

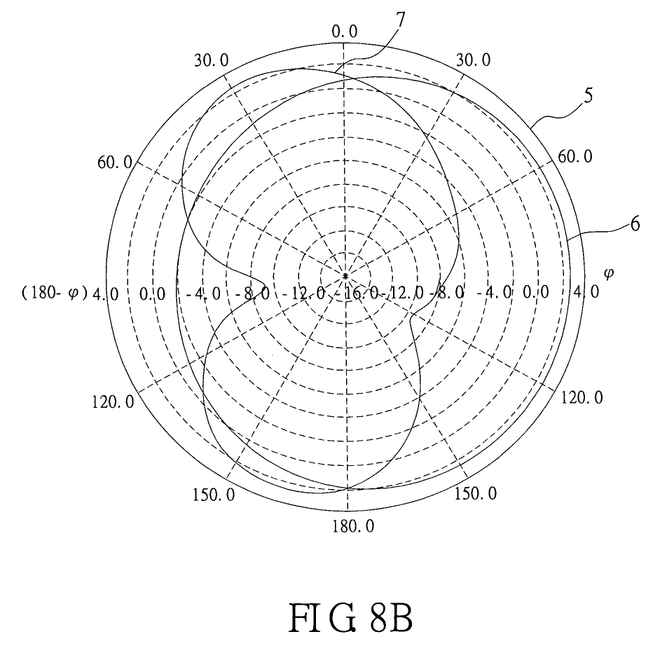

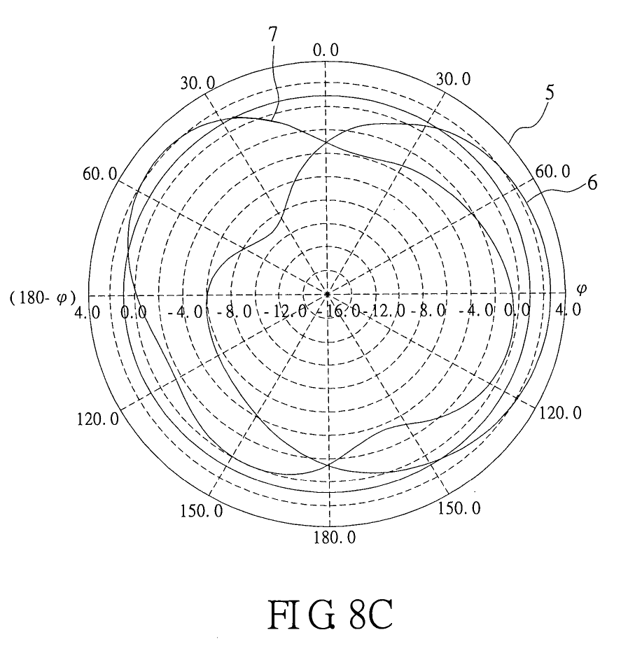

Reference is made to FIG. 7. FIG. 7 illustrates a frequency response plot of an antenna assembly according to the present invention. As shown in FIG. 7, the antenna assembly has a good capability of receiving and transmitting signals using electromagnetic waves at a first frequency band f1, a second frequency band f2 and a third frequency band f3. The first frequency band ranges from 850 MHz to 900 MHz. Reference is made to FIG. 8A. FIG. 8A illustrates a radiation pattern corresponding to the frequency response plot of an antenna assembly according to the present invention. In addition, the antenna assembly is positioned horizontally. FIG. 8A is the radiation pattern of the antenna assembly and describes how that signal is distributed in a 360-degree fashion. A circle 5 is a polar coordinate in the polar coordinate system. A circle 6 is referred to as the azimuth or “E-plane”, and a circle 7 is 8-shaped and referred to as the elevation or “H-plane”.

The second frequency band ranges from 1800 MHz to 1990 MHz. Reference is made to FIG. 8B. FIG. 8B illustrates a radiation pattern of the second frequency band. In addition, the antenna assembly is positioned horizontally. FIG. 8B is the radiation pattern of the antenna assembly and describes how that signal is distributed in a 360-degree fashion. A circle 5 is a polar coordinate in the polar coordinate system. A circle 6 is referred to as the elevation or “H-plane”, and a circle 7 is referred to as the azimuth or “E-plane”.

The wireless frequency (2.4 GHz) of the Bluetooth signals is at the third frequency band. Reference is made to FIG. 8C. FIG. 8C illustrates a radiation pattern of the third frequency band. In addition, the antenna assembly is positioned horizontally. FIG. 8C is the radiation pattern of the antenna assembly and describes how that signal is distributed in a 360-degree fashion. A circle 5 is a polar coordinate in the polar coordinate system. A circle 6 is referred to as the elevation or “H-plane”, and a circle 7 is referred to as the azimuth or “E-plane”.

As described above, advantages of the present invention are described as follows.

1. The present invention provides an antenna assembly. The antenna assembly uses a plurality of metallic sheets of the planar antenna structure to enlarge the operating frequency band of the antenna assembly. Thus, the present invention is used to receive and transmit signals using electromagnetic waves of three frequencies (900 MHz, 1800 MHz or 1900 MHz).

2. The present invention provides an antenna assembly. The planar antenna structure of the antenna assembly is adjusted to enlarge the operating frequency band of the antenna assembly and receive and transmit Bluetooth signals using a wireless frequency (2.4 GHz). Additionally, the frequency response of the antenna assembly is improved.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. An antenna assembly, comprising:
a planar antenna structure, having at least three metallic sheets to receive multiple frequency signals and produce a coupled effect; and
a conductor, electrically connected with a planar substrate and the planar antenna structure.

2. The antenna assembly as claimed in claim 1, wherein the planar substrate is made of metal.

3. The antenna assembly as claimed in claim 1, wherein the planar substrate is a printed circuit board.

4. The antenna assembly as claimed in claim 3, wherein the printed circuit board is made of Bakelite board, ceramic substrate, copper foil substrate, flexible board, hard board, metallic substrate, or thermoplastic substrates.

5. The antenna assembly as claimed in claim 1, wherein the planar antenna structure is planar.

6. The antenna assembly as claimed in claim 1, wherein the planar antenna structure is curved or winding.

7. The antenna assembly as claimed in claim 1, wherein the planar antenna structure is winding.

8. The antenna assembly as claimed in claim 1, wherein the metallic sheets are L-shaped or U-shaped.

9. The antenna assembly as claimed in claim 1, wherein a combination and a size of the metallic sheets are arbitrary.

10. The antenna assembly as claimed in claim 1, wherein frequencies of the metallic sheets correspond to a plurality of operating frequencies.

11. The antenna assembly as claimed in claim 10, wherein the frequencies are 00 MHz, 1800 MHz, 1850 MHz, 1990 MHz or 2450 MHz.

12. The antenna assembly as claimed in claim 1, wherein at least one metallic sheet is a ground and used as a ground wire.

13. The antenna assembly as claimed in claim 1, wherein the at least one metallic sheet is extended from the planar substrate to produce a coupled effect, and is not in contact with the metallic sheet of the planar antenna structure.
